(19) United States
(12) Patent Application Publication
(10) Pub. No.: US 2025/0033753 A1
(43) Pub. Date: Jan. 30, 2025

(54) AN OUTBOARD FOR WATERCRAFT

(71) Applicant: SAIETTA GROUP PLC, Oxfordshire (GB)

(72) Inventors: Wicher KIST, Oxfordshire (GB); Gerwin SCHINKEL, Oxfordshire (GB); Maik VAN DAR DOES, Oxfordshire (GB); Anne HERREMA, Oxfordshire (GB); Sander VAN DIJK, Oxfordshire (GB); Jan Roelof KORTSTRA, Oxfordshire (GB); Maurits DE KONING, Oxfordshire (GB); Peter COYSH, Oxfordshire (GB)

(21) Appl. No.: 18/709,179

(22) PCT Filed: Nov. 11, 2022
(86) PCT No.: PCT/GB2022/052878

§ 371 Date: May 10, 2024

(30) Foreign Application Priority Data
Nov. 11, 2021 (GB) 2116265.6

(51) Int. Cl. B63H 20/28; B63H 20/32; H02K 7/116; H02K 9/193; H02K 21/24

(52) U.S. Cl. CPC B63H 20/285; B63H 20/32; H02K 7/116; H02K 9/193; H02K 21/24

(57) ABSTRACT

The present disclosure relates to an outboard for a watercraft. The outboard has a body comprising a motor housing portion for housing an electric motor and a controller, and a closed cooling loop for cooling fluid to cool the electric motor and the controller when 5 housed in the motor housing portion. The outboard is configured such that a portion of the cooling loop is submerged when the outboard is in use.

### TECHNICAL FIELD

The present disclosure generally relates to outboard propulsion device arrangements and assemblies for use on watercraft.

### BACKGROUND

Watercraft, also known as water vessels or waterborne vessels, are vehicles used in and on water, including boats, ships, hovercraft, and submarines. Watercraft usually have a propulsive capability (whether by sail, oar, paddle, or engine) and hence are distinct from a simple device that merely floats, such as a log raft.

An “outboard” is a propulsion system for watercraft, consisting of a self-contained unit that may include a motor, a transmission system (e.g., including a gearbox) and propeller or jet drive, designed to be affixed to the outside of a transom of the watercraft. Outboards are a common motorised method of propelling small watercraft. As well as providing propulsion, outboards may also provide steering control, as they are designed to pivot about their mountings and thus control the direction of thrust. Skegs extending below a lower portion of the outboard act as a rudder when the engine is not running. Unlike inboards, outboards can be easily removed for storage or repairs.

Outboards are typically powered by an internal combustion engine (ICE). Some outboard configurations utilize a radial flux electric motor to drive a propeller. In use, both ICEs and radial flux motors generate a significant amount of heat and require a forced cooling system in order to maintain safe operating temperatures. Known outboard arrangements utilize an open loop cooling system in which water outside the outboard is drawn up through an intake in a lower portion of the outboard and pumped up through the outboard to the housing containing the ICE or electric motor. However, the presence of the water intake causes undesirable drag on the outboard when moving through the water, thereby reducing the efficiency of the drive system. Furthermore, the use of open loop cooling in salt water application causes rapid corrosion of the outboard cooling passages, reducing the service life and increasing maintenance costs.

The present disclosure addresses one or more of the deficiencies of the known outboard propulsion device arrangements.

### SUMMARY OF THE DISCLOSURE

Embodiments described herein provide outboard arrangements, assemblies and propellers for use on watercraft. As used herein, the term “outboard” connotes a propulsion device configured to be attached to an external surface, such as a transom, of the watercraft.

Throughout this disclosure, unless otherwise qualified, terms such as “radial”, “axial”, “circumferential” and “angle” are used in the context of a cylindrical polar coordinate system (r, ϑ, z) in which the direction of the axis of rotation of the electrical machine is parallel to the z-axis. That is, “axial” means parallel to the axis of the rotation (that is, along the z-axis), “radial” means any direction perpendicular to the axis of rotation, an “angle” is an angle in the azimuth direction ϑ, and “circumferential” refers to the azimuth direction around the axis of rotation.

Terms such as “radially extending” and “axially extending” should not be understood to mean that a feature must be exactly radial or exactly parallel to the axial direction. To illustrate, while it is well-known that the Lorentz force experienced by a current carrying conductor in a magnetic field is at a maximum when the direction of the current is exactly perpendicular to the direction of the magnetic flux, a current carrying conductor will still experience a Lorentz for angles less than ninety degrees. Deviations from the parallel and perpendicular directions will therefore not alter the underlying principles of operation.

### Outboard Propulsion Device With Closed Loop Cooling

According to a first aspect of the present disclosure, provided is an outboard for a watercraft, the outboard having a body comprising a motor housing portion for housing an electric motor and a controller, and a closed cooling loop, for cooling fluid, configured to cool the electric motor and the controller when housed in the motor housing portion, wherein the cooling loop is configured such that a portion of thereof is submerged in water when the outboard is in use.

Closed loop cooling systems avoid undesirable drag on the outboard through the water caused by the need for water intakes on the lower section of the outboard. Furthermore, use of a closed loop cooling system enables the use of cooling fluids other than water/salt water having improved cooling properties and/or non-corrosive properties.

As will be appreciated, reference to the outboard being “submerged in water” refers to the water within which the watercraft is being used.

At least a portion of the cooling loop is preferably situated adjacent an outer surface of the outboard, the outer surface being submerged in water when the outboard is in use, which cools the cooling fluid within the cooling loop adjacent the outer surface.

The cooling loop preferably extends through a mid-section of the outboard, the cooling loop in the mid-section having a cool side leading to the motor housing portion and a hot side leading from the motor housing portion to a submerged portion of the outboard. The hot side of the cooling loop is preferably situated adjacent a front surface of the mid-section when the outboard is in use. The front side of the outboard mid-section may receive a greater flow of water/air across its outer surface when the outboard is in use. Heat transfer from the front side of the mid-section is therefore greater than that from other sides of the mid-section. Preferably, the cold side of the cooling loop is thermally separate from the hot side of the cooling loop to prevent the hot side heating the cold side in order to maximise cooling efficiencies. In some cases, the cold side of the cooling loop may be situated in an opposite side of the mid-section to the hot side. In some cases, thermal insulation may be provided between the hot side and the cold side of the cooling loop.

The cooling loop is preferably configured such that when the controller and electric motor are housed within the motor housing portion the cool side of the cooling loop is configured to cool the controller before cooling the electric motor. Typically, the controller will generate more heat than the electric motor so requires greater cooling. The controller may be integrated with the electric motor.

The cooling loop preferably comprises a heat exchanger. Preferably, the heat exchanger is provided in a portion of the outboard body which is configured to be submerged in water when the outboard is in use. In such configurations, water passing the outer surface of the outboard encourages heat removal from the cooling fluid in the heat exchanger. Preferably, the heat exchanger is positioned adjacent to a front surface of the body of the outboard when in use to maximise heat transfer from the heat exchanger.

The heat exchanger preferably comprises a larger effective cross-sectional area than other portions of the cooling loop which put the motor housing portion in fluid communication with the heat exchanger. Such configurations maximise the volume of cooling fluid in contact with the inner surface of the heat exchanger, thereby providing improved cooling to a greater volume of cooling fluid flowing through the heat exchanger. In addition, having a larger effective cross-sectional area reduces the flow velocity of the cooling fluid through the heat exchanger compared to the flow velocity through the other portions of the cooling loop which put the motor housing portion in fluid communication with the heat exchanger, thus comparatively increasing the amount of time that the cooling fluid is within the heat exchanger. In some configurations, the heat exchanger may comprise a U-shaped channel, wherein outer surfaces of the U-shaped channel are situated adjacent to outer surfaces of the outboard. In this case, the U-shaped channel may extend along lateral sides of the outboard. It will however, be appreciated that other heat exchanger geometries having larger inner and/or outer surface areas compared to other sections of the cooling loop can be used.

The cooling loop may substantially extend about the electric motor and the controller. Optionally, the cooling loop is configured such that a wall portion of the cooling loop is formed of an external surface of the electric motor and/or the controller. The cooling loop may be configured to extend between the electric motor and the controller.

A lower portion of the outboard, configured to be submerged in water when the outboard is in use, may comprise cooling channels configured to direct water across the cooling loop. When provided, the cooling channels preferably direct water across the heat exchanger. The cooling channel may comprise cooling fins, coupled to the heat exchanger. The cooling fins increase the cooling potential due to the increased surface area. The cooling fins are preferably elongate, and may be arranged such that their longitudinal axis is substantially aligned with the fluid flow streamlines of the water. The cooling channels may be open or closed. As will be appreciated, the cooling channels are configured such that the pressure drop from the inlet of the channel to the outlet is minimised.

The cooling loop preferably comprises a coolant pump configured to pump cooling fluid around the cooling loop. The direction in which cooling fluid is pumped around the cooling loop will determine the hot and cold sides of the cooling loop. Pumping the cooling fluid ensures that a strong flow of cooling fluid around the cooling loop, which greatly improves heat transfer from the motor housing portion compared with a cooling loop reliant on convection currents.

The cooling fluid preferably comprises at least one of: glycol; a dielectric fluid; deionised water; water/ethylene glycol; water/propylene glycol; Dynalene HC-30; Galden HT200; and Fluorinert FC-72. Such cooling fluids exhibit improved coolant/non-corrosive properties compared to those of the water/salt water in which the outboard is situated in use, thereby improving the performance and/or life of the outboard.

The cooling loop preferably comprises an expansion vessel for controlling coolant pressure and/or coolant fill-level. The expansion vessel can be used to remove any air from the cooling loop to maximise cooling efficiencies.

The motor housing portion of the outboard preferably comprises a stator housing for an axial flux electrical machine. The motor housing portion may comprise a cylindrical body defining an inner cavity for receiving an axial flux electrical machine. The cylindrical body may have a circular cross-section. Preferably the cylindrical body has a greater diameter than height. More preferably, the cylindrical body has a diameter of more than two times its height. Such cylindrical body dimensions make the motor housing portion particularly adapted to the geometries of axial flux electrical machines in order to reduce the overall weight and size of the outboard. Compatibility with an axial flux electrical machine is particularly advantageous for an outboard due to the inherent size and weight savings over the corresponding radial flux electrical machines. Furthermore, in use, axial flux electrical machines generate significantly less heat which reduces the burden on the cooling system to maintain safe operating temperatures within the outboard.

Preferably, the stator housing is integral to the motor housing portion. In some configurations, the stator housing is extruded from the motor housing portion of the outboard. Providing an integral stator housing within the outboard helps reduce the overall weight of the outboard and therefore improves the outboards propulsion performance.

The stator housing is preferably tubular and substantially cylindrical in shape, wherein the inner surface of the stator housing comprises a plurality of recesses, each recess configured to receive an outer part of a conductive coil of the stator of the axial flux electrical machine.

The cross-section of each recess, perpendicular to the axis of rotation of the axial flux electrical machine, is preferably elongate, the major dimension of each elongate recess extending substantially in the radial direction of the axial flux electrical machine. Each elongate recess preferably has an aspect ratio of between about 5 and about 15. The aspect ratio of each recess may be between about 7 and about 12, more preferably between about 7 and about 10.

The side walls of each recess are preferably substantially parallel to the rotational axis of the axial flux electrical machine.

The circumferential distance between adjacent recesses is preferably between about 1 times and about 3 times the width of each recess.

The stator housing preferably further comprises an annular ring configured to form an annular channel adjacent the circumferential outer surface of said stator housing. The stator housing preferably further comprises a spacer configured to divide said annular channel, the spacer extending from a first axial end of said stator housing to a second axial end of said stator housing. In this way, the spacer positions the annular ring relative to the stator housing outer surface to form the annular channel, and divides the annular channel such that it forms a C-shape. The spacer preferably mechanically couples the stator housing to the annular ring. The annular ring preferably comprises a cooling fluid inlet disposed adjacent a first side of said spacer, and a cooling fluid outlet disposed adjacent a second side of said spacer, the inlet and the outlet being in fluid communication with the annular channel. As will now be appreciated, the spacer divides the annular channel such that cooling fluid flow proceeds circumferentially around the annular channel. The annular ring preferably forms a portion of the cooling loop.

In a preferred example of the present disclosure, the stator housing is formed by extrusion. In this preferred example, the plurality of recesses are preferably formed from a first set of protrusions extending from the inner surface of the stator housing and a second set of protrusions extending from the inner surface of the stator housing, wherein the first set of protrusions are formed integrally with said stator housing, and the second set of protrusions are formed separately and positioned within said stator housing.

The second set of protrusions are preferably mechanically attached to said stator housing. The first set of protrusions are preferably interlaced with said second set of protrusions. Advantageously, forming the stator housing and recesses in this manner improves the manufacturability of the stator housing. The minimum thickness of any feature of the extrusion tool used to form the stator housing may be increased, such that the tool life is significantly increased.

The first set of protrusions are preferably interlaced with said second set of protrusions such that each protrusion from the first set of protrusions is adjacent a protrusion from the second set of protrusions.

Each of the second set of protrusions may comprise a key configured to engage with a corresponding slot formed in the inner surface of the extruded stator housing to mechanically attach each protrusion thereto. In some configurations, each of the second set of protrusions comprises a slot configured to engage with a corresponding key formed on the inner surface of the extruded stator housing to mechanically attach each protrusion thereto.

The second set of protrusions may be formed by extrusion. The stator housing may be extruded as a single part. That is to say, the main tubular body of the stator housing may be formed as a single part. Alternatively, the stator housing may be formed of a plurality of circumferentially-interlocking extruded segments. In an example, the housing may be extruded as a plurality of interlocking arcuate segments. The housing may be formed of two, three, four, five or more interlocking arcuate segments. In one further example, the extruded housing may be formed of two sections, a first outer section and a second inner section, the inner section comprising the plurality of recesses. The inner section may comprise a plurality of sub-sections, each sub-section comprising at least one recess. The second inner section preferably interlocks with said first outer section.

When the stator housing comprises an annular ring, the annular ring is preferably formed by extrusion. When the annular ring is spaced apart from the outer surface of the tubular body of the stator housing by a spacer, the spacer is preferably formed of a slot and key, the slot being formed on one of an inner surface of said annular ring and the outer surface of said stator housing, the key being formed on the other of the inner surface of said annular ring and the outer surface of said stator housing.

Preferably, the extruded stator housing has an outer surface which is shaped so as to increase the overall surface area of the outer surface of the extruded stator housing. The outer surface of the extruded stator housing may include cooling fins or a heatsink.

The stator housing may further comprise at least one recess or channel in which a liquid cooling arrangement is accommodated. Alternatively, the stator housing may comprise at least two recesses or channels, in which the liquid cooling arrangement is accommodated, arranged on opposed axial ends of said stator housing. Preferably, the liquid cooling arrangement is fluidly coupled with the cooling loop described above.

The or each recess or channel may be substantially annular. The or each recess or channel may be substantially adjacent the outer parts of conductive coils in a stator of an axial flux electrical machine when mounted within the stator housing of the outboard.

An inner surface of the stator housing preferably comprises a plurality of recesses, each recess configured to receive at least an outer part of a conductive coil of a stator of an axial flux electrical machine. Each recess is preferably elongate, the major dimension of each elongate recess extending substantially in the radial direction of the axial flux electrical machine. The sides of each recess are preferably substantially parallel to the rotational axis of the axial flux electrical machine. The circumferential distance between adjacent recesses is preferably between about 1 times and about 3 times the width of a recess.

The liquid cooling arrangement within the stator housing may comprise a pipe for receiving cooling liquid, the pipe being in contact with the housing or, in addition, via a thermally conductive material to improve the heat transfer between the housing and the pipe. The thermally conductive material may be one of: a resin; a paste; and a putty.

Preferably, the pipe forming the liquid cooling arrangement provides an inlet and outlet on an outer face of the stator housing for coupling with the cooling loop described above. Alternatively, the recess or channel may be configured to directly receive cooling liquid, the housing further comprising at least one plate configured to seal said at least one recess or channel.

The stator housing may further comprise at least one further channel provided on an axial end of said stator housing. Preferably said further channel is in fluid communication with said at least one recess or channel. The further channel may be axially located between a rotor of an axial flux electrical machine and a controller of the axial flux electrical machine. In this way, the single liquid cooling arrangement may cool both the axial flux electrical machine and the controller for the axial flux electrical machine.

The stator housing may yet further comprise an external annular channel provided adjacent the circumferential face of said stator housing. Preferably, the external annular channel is in fluid communication with the or each other recess or channel.

Preferably, the liquid cooling arrangement is connected to the closed cooling loop described above, wherein a cooling liquid is passed into the inlet of the cooling arrangement within the stator housing, around the pipe, and out of the outlet of the cooling arrangement, into a radiator or heat exchanger, through a pump, and then back in to the inlet of the cooling arrangement.

The stator housing may be formed by extrusion as described above, the at least one recess or channel being subsequently machined.

The stator housing may comprise circumferentially distributed and axially extending apertures for receiving the outer parts of the conductive coils that are substantially parallel to the axis of rotation. As noted above, this provides for easier and more accurate manufacture and heat transfer from the conductive components of the stator through the stator housing.

The outboard preferably comprises a skeg coupled to the lower section, the skeg extending beneath a lower section of the outboard. The skeg protects a propeller coupled to the lower section of the outboard from damage by engaging with any object or surface in front of the propeller. The skeg is preferably made from a less durable material than the lower section so that when significant forces arise on the skeg when engaging with an object or surface, the skeg is configured to preferentially break in order to avoid damaging other sections of the outboard.

The disclosure further provides an outboard assembly comprising an outboard as described above, an axial flux electrical machine housed within the motor housing portion, a propeller coupled to a lower section of the outboard, and a drive coupling extending between the axial flux electrical machine and the propeller.

The outboard assembly preferably further comprises a tiller coupled to the outboard for controlling a propulsion direction for the outboard. Alternatively, the outboard assembly further comprises means for attaching a remote steering system.

The outboard assembly preferably further comprises a coolant pump for pumping cooling fluid around the cooling loop of the outboard. In one configuration, the coolant pump may be powered by the axial flux electrical machine. In a preferred configuration, the outboard assembly comprises a separate electric motor for powering the coolant pump. Use of a separate electric motor for the coolant pump allows greater control of the flow of coolant around the cooling loop.

The disclosure further provides a watercraft comprising the outboard assembly disclosed above.

### Outboard for Housing an Axial Flux Electric Machine

According to a second aspect of the present disclosure, there is provided an outboard comprising a lower section for connection with a propeller, an upper section configured to mount an axial flux electrical machine, and a mid-section for housing a drive coupling extending between the axial flux electrical machine when housed in the upper section and the propeller when connected to the lower section. As described above, compatibility with an axial flux electrical machine is particularly advantageous for an outboard due to the inherent size and weight savings over the corresponding radial flux electrical machines. Furthermore, in use, axial flux electrical machines generate significantly less heat which reduces the burden on cooling systems to maintain safe operating temperatures within the outboard.

The upper section may comprise a cylindrical body defining an inner cavity configured to mount an axial flux electrical machine. The cylindrical body may have a circular cross-section. Preferably the cylindrical body has a greater diameter than height. More preferably, the cylindrical body has a diameter of more than two times its height. Such cylindrical body dimensions make the motor housing portion particularly adapted to the geometries of axial flux electrical machines in order to reduce the overall weight and size of the outboard.

The upper section of the outboard may comprise a stator housing for the axial flux electrical machine. The stator housing may be integral to the upper section. The stator housing may be extruded from the upper section of the outboard.

The lower section, the mid-section and the upper section preferably cooperate to define a cooling passage for cooling fluid to cool the axial flux electrical machine when housed in the upper section. The cooling passage preferably forms a closed loop within the outboard.

As described above, closed loop cooling systems avoid undesirable drag on the outboard through the water caused by the need for water intakes on the lower section of the outboard. Furthermore, use of a closed loop cooling system enables the use of cooling fluids other than water having improved cooling/non-corrosive properties.

The cooling passage preferably fluidly couples the upper section of the outboard with a heat exchanger for cooling the cooling fluid in the cooling passage. The heat exchanger preferably comprises a portion of the outboard which is configured to be submerged in water when in use. By configuring the outboard such that, when the outboard is in use, the heat exchanger is submerged in water results in natural cooling of the cooling fluid within the heat exchanger.

The cooling passage preferably comprises a coolant pump housing portion for housing a coolant pump for pumping cooling fluid through the cooling passage.

The upper section preferably comprises a controller housing for housing a controller for controlling the axial flux electrical machine when housed in the outboard. Preferably, the cooling passage is further configured such that cooling fluid flowing through the cooling passage cools the controller when housed within the outboard.

The upper section preferably comprises one or more cover plates for covering one or more rotors of the axial flux electrical machine when housed within the upper section.

The stator housing is preferably tubular and substantially cylindrical in shape, wherein the inner surface of the stator housing comprises a plurality of recesses, each recess configured to receive an outer part of a conductive coil of the stator of the axial flux electrical machine.

The disclosure further provides an outboard assembly comprising an outboard as described above, an axial flux electrical machine mounted within the upper section, a propeller coupled to a lower section of the outboard, and a drive coupling extending between the axial flux electrical machine and the propeller. The outboard assembly preferably comprises a tiller coupled to the upper section of the outboard.

The outboard assembly preferably comprises a coolant pump for pumping cooling fluid around the cooling loop of the outboard. In one configuration, the coolant pump may be powered by the axial flux electrical machine. In a preferred configuration, the outboard assembly comprises a separate electric motor for powering the coolant pump. Use of a separate electric motor for the coolant pump allows greater control of the flow of coolant around the cooling loop.

The disclosure further provides a watercraft comprising the outboard assembly disclosed above.

### Propeller

According to a third aspect, the disclosure provides a propeller comprising a plurality of blades, wherein at least one of the plurality of blades comprises a cutting portion for cutting fouling.

The cutting portion may preferably be provided on a leading edge of the at least one blade. Providing the cutting portion on a leading edge of the propeller blade, increases the likelihood that fouling, such as an entangled fishline, engages with the cutting portion of the propeller blade with sufficient force to cut the fouling. Preferably, each of the plurality of blades comprise a cutting portion.

Preferably, the cutting portion comprises a v-shaped blade portion situated at a central portion of a propeller separating adjacent blades at their base. As a fouling, such as a fishline, becomes increasingly entangled around the propeller, the fouling migrates towards a central portion of the propeller, at the base of the propeller blades. The provision of a v-shaped blade portion at the base of adjacent propeller blades guides foulings onto the cutting portion as they become entangled around the propeller blades.

Preferably, the cutting portion comprises a sharper edge than other edges of the blade.

Preferably, the cutting portion is made from a more durable material than other portions of the blade.

Preferably, the cutting portion is coated with a coating comprising at least one of polytetrafluoroethylene (PTFE), chromium nitride (CrN), boron carbide (B4C), molybdenum disulphide (MoS2), titanium nitride (TiN), titanium carbo-nitride (TiCN), aluminium-titanium nitride (AlTiN), or diamond-like carbon (DLC). Such coatings may preserve the effectiveness of the cutting portion over time.

The disclosed propeller arrangements may be used on any of the outboard arrangements/assemblies described above.

Any feature in one aspect of the disclosure may be applied to other aspects of the disclosure, in any appropriate combination. In particular, method aspects may be applied to apparatus aspects, and vice versa. Furthermore, any, some and/or all features in one aspect can be applied to any, some and/or all features in any other aspect, in any appropriate combination.

It should also be appreciated that particular combinations of the various features described and defined in any aspects of the disclosure can be implemented and/or supplied and/or used independently.

### BRIEF DESCRIPTION OF THE DRAWINGS

Embodiments of the disclosure will now be further described by way of example only and with reference to the accompanying figures in which:

FIG. 1(a) is a schematic view of an outboard assembly according to an embodiment of the disclosure.

FIG. 1(b) is a cross-sectional view of the outboard assembly of FIG. 1(a).

FIG. 1(c) shows the outboard assembly of FIG. 1(b) having a cooling loop superimposed thereon;

FIG. 2 is a cross-sectional view of a mid-section of an outboard according to an embodiment of the disclosure.

FIG. 3 is a perspective view of a heat exchanger according to an embodiment of the disclosure.

FIG. 4 is a perspective view of the lower section of the outboard assembly of FIGS. 1.

FIG. 5(a) is a perspective view of a stator assembly, including a stator housing that houses the conductive coils of a stator assembly;

FIG. 5(b) is a plan view of the stator assembly of FIG. 6(a), showing how the conductive coils are received within the stator housing apertures;

FIG. 5(c) is a perspective view of the stator assembly of FIG. 6, showing the busbars and phase connections;

FIG. 6(a) is a perspective view of an extruded housing for an axial flux electrical machine as described herein;

FIG. 6(b) is a plan view of an extruded housing for an axial flux electrical machine as described herein; and

FIG. 7 is a perspective view of a housing comprising a cooling system for an axial flux electrical machine as described herein.

Like reference numbers are used for like elements throughout the description and figures.

### DETAILED DESCRIPTION

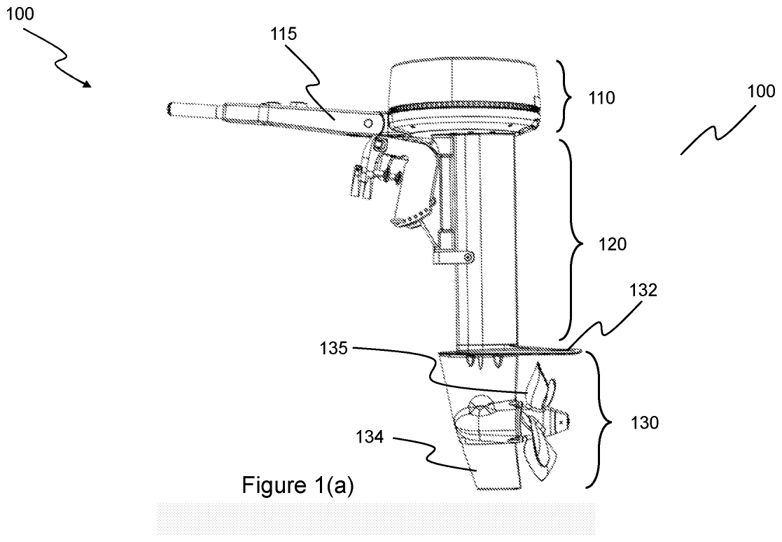

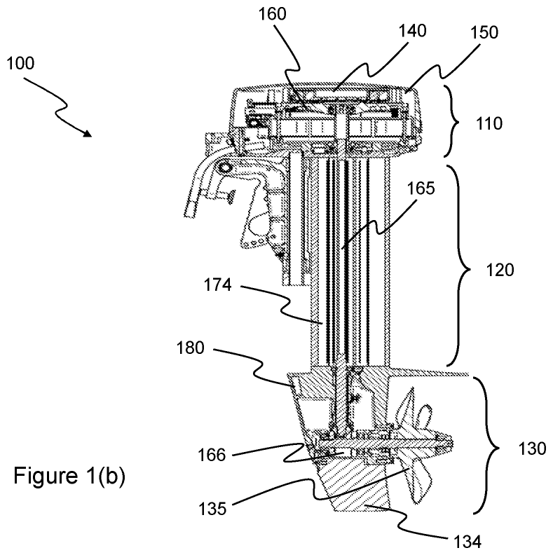

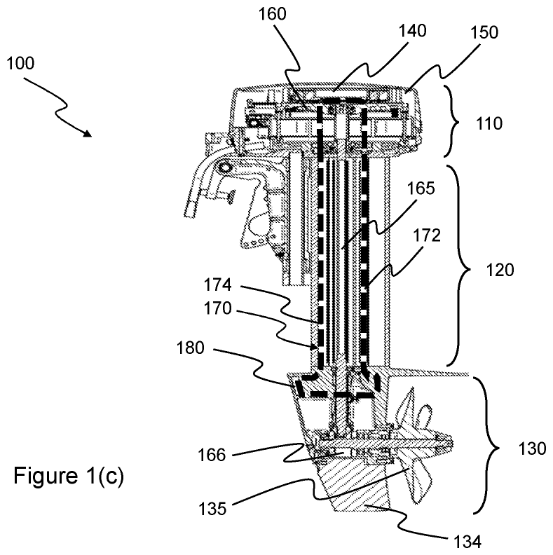

FIG. 1(a) illustrates an outboard propulsion device 100 for a watercraft. The outboard 100 comprises an upper section 110, a mid-section 120 and a lower section 130. Coupled to upper section 110 is a tiller 115 for altering the propulsion direction of the outboard 100. It will, however, be appreciated that other known outboard steering mechanisms may be used. In some embodiments, the steering mechanism may be coupled to the mid-section 120 or lower section 130 of outboard 100. Mid-section 120 structurally connects upper section 110 to lower section 130. Lower section 130 comprises a tail 132 and skeg 134 for improving the stability of outboard 100 and providing protection to a propeller 135 coupled to lower section 130. It will be appreciated that propulsion systems other than propellers may be used, such as jet drives.

As can be seen in FIG. 1(b), upper section 110 comprises a motor housing portion 140 for mounting an axial flux electrical machine 150 and a controller 160. In some embodiments, motor housing portion 140 comprises a stator housing for housing the stator of an axial flux electrical machine 150, as described in detail below.

Mid-section 120 provides a passage 165 for housing a drive coupling between axial flux electrical machine 150 and propeller 135. In some embodiments, the drive coupling may comprise an axle coupled to one or more rotors of axial flux electrical machine 150 leading down through mid-section 120 to a transmission housing 166 housed within lower section 130. Transmission housing 166 comprises a gearbox.

Extending through outboard 100 is a closed cooling loop 170 having a cold side 172 and a hot side 174. The cooling loop 170 is shown as a dotted line in FIG. 1(c). The cold side 172 of cooling loop 170 leads from a heat exchanger 180 in lower section 130 along a rear side of mid-section 120 to motor housing portion 140 in upper section 110, while hot side 174 of cooling loop 170 leads from motor housing portion 140 in upper section 110 along a front side of mid-section 120 back to heat exchanger 180 in lower section 130.

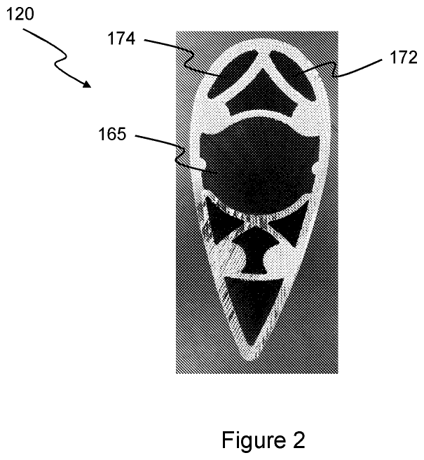

FIG. 2 illustrates a cross-section of mid-section 120 according to an embodiment of the disclosure. As shown in FIG. 2, mid-section 120 comprises two cooling passages 172, 174 in a front side of the mid-section 120 for the cold and hot sides of cooling loop 170. Central passage 165 is provided for housing a drive coupling as described above.

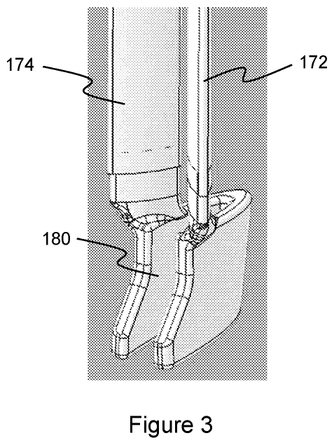

FIG. 3 illustrates a perspective view of heat exchanger 180 according to an embodiment of the disclosure. Heat exchanger 180 comprises a U-shaped channel maximising the volume of cooling fluid received via hot side 174 of cooling loop 170 in contact with the surface of the heat exchanger 180. However, it will be appreciated that other heat exchanger geometries which increase either the inner or outer surface area of the heat exchanger 180 will also be suitable.

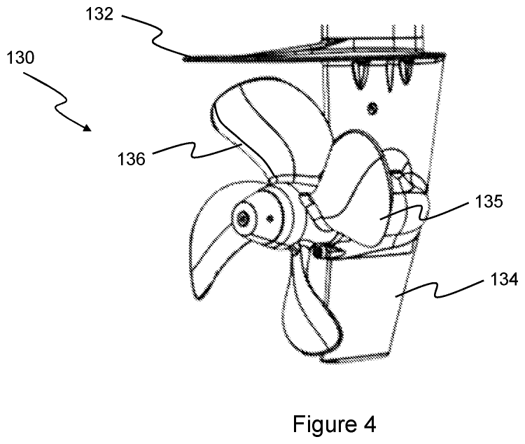

FIG. 4 illustrates a perspective view of a lower section 130 of outboard 100 according to an embodiment of the disclosure. As seen in FIG. 4, propeller 135 comprises a cutting portion 136 on the leading edge of each propeller blade. However, as described above, the number of cutting portions 136 on propeller 135 may vary.

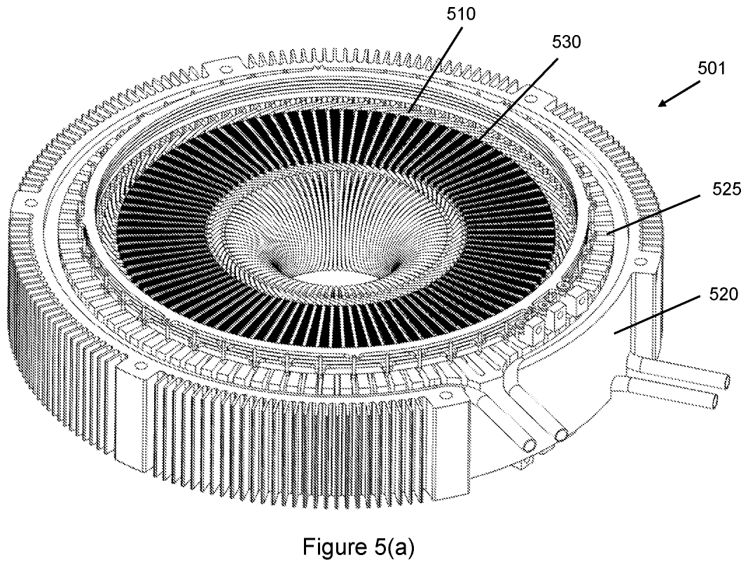

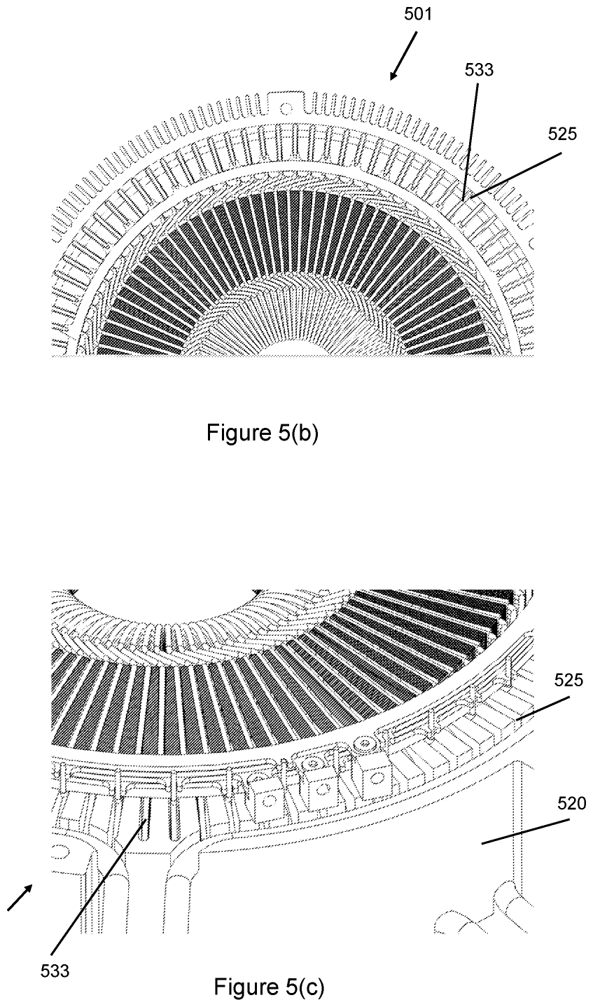

Turning to FIGS. 5(a)-5(c), there is illustrated an axial flux electrical machine stator assembly 501 which can be seen to include an annular or ring-shaped stator housing 5020 which houses the conductive components 510 of the stator 501. The core of the stator assembly 501, where the axial flux provided by the rotor magnets interacts with the radially flowing current flowing through the conductive components 10 to generate the torque that causes rotors to rotate, includes radially extending active sections of the conductive components 510 of the stator and flux guides in the form of lamination packs. The flux guides, in the form of lamination packs, which may comprise grain-oriented electrical steel sheets surrounded by electrical insulation, are positioned in spaces between the radially extending active sections of the conductive components 510 of the core. The flux guides, in the form of lamination packs, act to channel the magnetic flux produced by the permanent magnets between the current carrying conductors.

The stator housing 520 may be provided with a plurality of circumferentially spaced apart axially extending apertures 525 for receiving the coils. This makes the positioning of the coils in the stator housing easier and more precise. Advantageously, if the coils are formed so as to have an axially extending outer part 533, the axially extending outer part 533 can be received within the axially extending apertures 525. Since the axially extending outer part 533 have a large surface area, they provide good mechanically locking of the coils in the stator housing for assembly without the need for glue (for example) and also provide a source of cooling of the stator.

Axial flux electrical machines comprising the stator assembly 501 described herein have been found to provide not only a high peak efficiency, but a high efficiency over a broad range of operating parameters. While high peak efficiencies are often quoted, they are in practice rarely achieved, especially in applications where the machine is required to perform over a range of operating parameters. Efficiency over a broad range of parameters is therefore a more practically meaningful measure for many applications.

There may be a number of different reasons for the high efficiencies which the stator assembly 501 is able to achieve. Some of these will now be described.

First, as explained above, the almost self-forming structure of the conductive components of the stator 510 that is provided by the geometry of the coils allows for the very accurate placement of components of the stator core. The accurate placement of the components of the core means that there is better coupling of the stator and rotor fields, and a high degree of symmetry around the circumference of the stator which improves the generation or torque.

Another significant advantage is the generation of a stator field with a more accurately sinusoidal magnetic flux density. As will be understood by those skilled in the art, the higher the number of slots per pole per phase in the stator, the more sinusoidal the magnetic flux density can be. The coils and stator 510 described above can provide an increased number of slots per pole per phase by increasing the number of conductive elements per conductive coil, and this number can easily be scaled up (if, for example, the radius of the stator can be increased for a particular application). An advantage of a highly sinusoidal magnetic flux density is that the flux density has a relatively low harmonic content. With a low harmonic content, more of the coupling the rotor and stator fields involves the fundamental components of the flux density, and less involves the interaction with the harmonic components. This reduces the generation of eddy currents in the rotor magnets, which in turn reduced losses due to heating. In contrast, many known axial flux motors utilize a concentrated winding arrangement which only provides for a limited number (e.g. fractional) slot per pole per phase, which generates a much more trapezoidal flux density with more significant harmonic components.

While the coils can be implemented using axially extending strips, they are preferably implemented using an axially stacked winding arrangement. While many motor manufacturers may consider this a disadvantage because it may be considered to reduce the fill factor in the stator core, the inventors have found this disadvantage is compensated for by the reduction in the skin and proximity effects which causes currents to flow around the outside of the conductor cross-section and predominantly the axially-outer portions of the active sections. The number of windings in the axial direction may be selected to balance these two considerations.

### Stator Housing

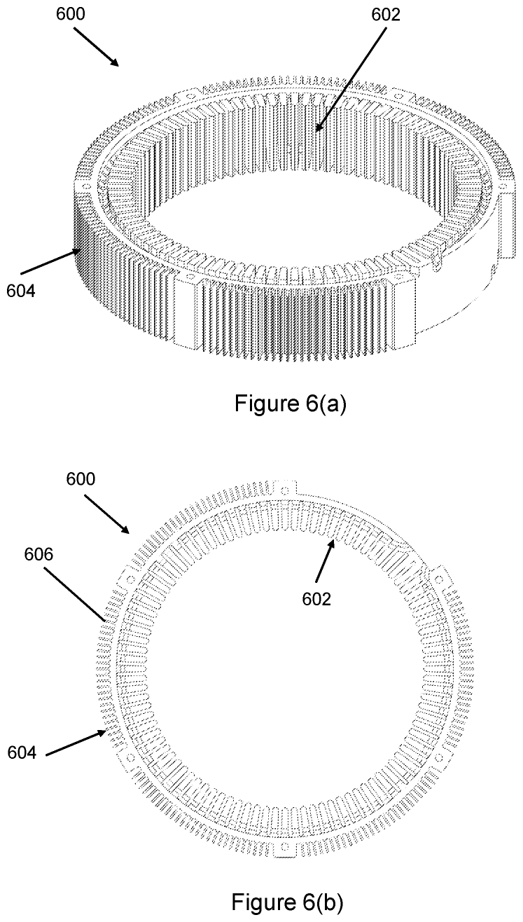

The axial flux electrical machine described herein may comprise an extruded stator housing, such that the conductive coils of the stator assembly 501 are provided within the housing. As can be seen in FIGS. 6(a) and 6(b), the housing 600 is generally tubular and cylindrical in shape, with an inner face 602 and an outer face 604.

The outer face may be shaped so as to increase the overall surface area of the outer face of the extruded housing, such as including cooling fins 606 or a heat sink formed therein.

In increasing the surface area of the outer surface of the axial flux electrical machine, the extruded housing 600 of the axial flux electrical machine may increase the rate at which heat energy may be dissipated from the axial flux electrical machine. Cooling of the axial flux electrical machine will be discussed in more detail below.

Previously-proposed axial flux electrical machine housings have employed stacked, stamped plates, in order to reduce eddy currents in the housing. As discussed above, the presence of eddy currents in an axial flux electrical machine in accordance with the present disclosure is limited, and as stated above, this may be an effect of the axial flux machine being driven from the fundamental magnetic field components and less from the harmonic components.

The limited presence of eddy currents may enable the housing 600 of the axial flux electrical machine in accordance with the present disclosure to be formed of an extruded section as opposed to stacked, stamped plates. In turn, this may result in improved manufacturability and/or cost savings; for example the assembly complexity may be reduced, and therefore the assembly time may be reduced.

Forming the housing 600 of the axial flux electrical machine as a single extruded section may also improve the structural rigidity of the axial flux electrical machine. It may also reduce the weight.

Additionally, the extruded housing of the axial flux electrical machine comprises, on the inner face 602 thereof, a series of recesses which accommodate the outer sections of the coils of the stator assembly 501, to improve the heat dissipation from the coils. This will be discussed in more detail later.

The extruded housing described above may be used to improve the cooling performance of axial flux electrical machines in accordance with the present disclosure, as briefly described above.

As stated above, the outer face of the extruded housing of the axial flux machine may be shaped so as to increase the overall surface area of the outer face of the extruded housing, such as including cooling fins or a heatsink formed therein. It may therefore be advantageous to maximise the heat transfer from the stator assembly 1 of the axial flux electrical machine into the extruded housing.

Efficient cooling of the axial flux electrical machine in accordance with the present disclosure may also be promoted by the shape and orientation of the coils within the axial flux machine, and particularly the shape and orientation of the outer portion of the coils which are at the outer edge of the stator 501. The cooling performance of the axial flux electrical machine may be improved by increasing the rate at which heat energy may be dissipated from the coils of the stator 501.

To increase the rate at which heat energy may be dissipated from the stator 501, the heat energy may advantageously be transferred into the extruded housing of the axial flux electrical machine. To this end, the inner face of the extruded housing of the axial flux machine may include a lip, recess, or face which is shaped such as to make thermal contact with the outer portions of the coils of the stator 501, and therefore to enable heat transfer from the coils of the stator into the extruded housing of the axial flux machine. As discussed above, the outer portion of each of the coils have a surface that is substantially parallel to the axis of rotation, with the inner face of the housing including a complementary recess for the outer portion of each of the coils.

The coils of the stator are encased within a potting compound which has a high heat transfer capacity, to promote efficient heat energy transfer from the coils of the stator. In addition, a thermal paste or heat transfer compound may be placed between the flat section of each of the coils and the inner face of the extruded housing to increase the heat transfer capacity further.

The heat energy may then be dissipated into the air, through the cooling fins or heat sink of the outer face of the extruded housing.

The extruded housing may also include a recess, channel, or similar in which to accommodate a liquid cooling arrangement. This liquid cooling arrangement may be used to increase the rate at which heat energy may be dissipated from the axial flux electrical machine, and therefore to improve the cooling performance of the axial flux machine. Advantageously, the recess, or channel, may be provided such that it is immediately adjacent the curved portion of the outer sections of the coils.

Liquid cooling, for example water cooling, may deliver more effective cooling performance than air cooling. This is because water has a greater specific heat capacity than air, and the specific heat capacity of water is over four times greater than that of air.

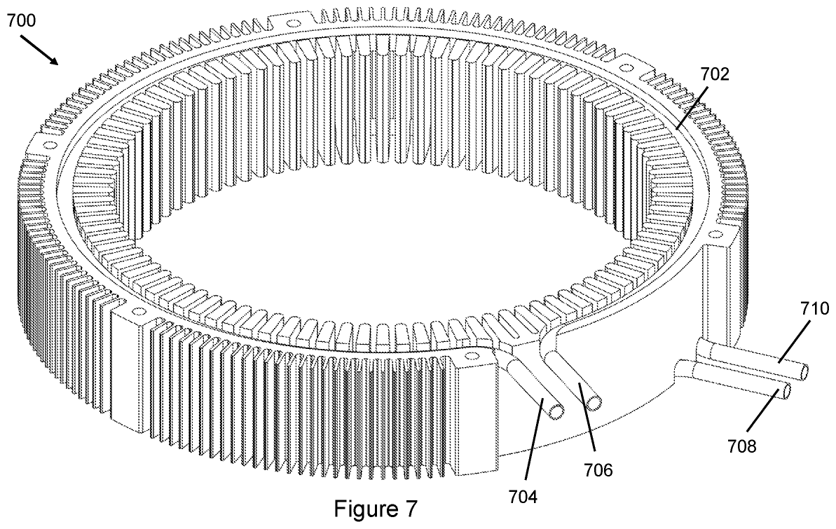

Such a liquid cooling arrangement is shown in FIG. 7. The liquid cooling arrangement within the extruded housing 700 may, for example, comprise a pipe 702 formed of a material with high heat conductivity properties, such as copper, and may be in contact with the extruded housing directly, or additionally, via a thermal paste or putty to improve the heat transfer between the extruded housing and the pipe 702. The pipe 702 forming the liquid cooling arrangement provides an inlet 704 and outlet 706 on the outer face of the extruded housing 700. A further pipe (not shown) is provided on the opposite face of the extruded housing 700, and provides a similar inlet 708 and outlet 710.

Cooling water is fed into the inlets 704, 708 of each pipe, and removed from the outlets 706, 710 of the pipe. The cooling water is supplied into the inlet of the pipe at a reduced temperature, and may be fed out of the outlet into a radiator, heat exchanger, phase-change cooler or similar, before returning to the inlet. This may be considered a cooling ‘circuit’. If the axial flux electrical machine is to be used, for example, in a vehicle, the heat energy transferred from the axial flux electrical machine into the cooling water may be used to heat the cabin of the vehicle, or to maintain the temperature of the battery packs of the vehicle, by way of a heat exchanger.

The cooling fins and/or heatsink may be employed in combination with a liquid cooling arrangement in order to maximise the rate at which the heat energy may be dissipated from the axial flux electrical machine.

The cooling circuit may be a closed loop system, such that the cooling liquid, for example water, is passed into the inlet of the cooling arrangement within the extruded housing, around the cooling channel which may form the cooling arrangement, and out of the outlet of the cooling arrangement, into a radiator, heat exchanger or similar (to transfer the heat energy from the cooling liquid into the air, or to another cooling or heating system, likely through a pump, and then back in to the inlet of the cooling arrangement.

In the case that the cooling circuit is a closed loop system, and the loop includes a radiator, the radiator may include forced cooling in the form of a fan or fans, to promote airflow through the radiator and to improve the cooling performance of the cooling circuit.

As mentioned above, in the case of a vehicle, the heat may be transferred from the axial flux electrical machine cooling circuit and into, for example, the heating circuit of the vehicle, or a heater to maintain the temperature of the battery pack of the vehicle. Maintaining the temperature of a battery pack in a vehicle may increase the performance of the battery pack; a low temperature may reduce the performance of the battery pack, thus reducing the range of the vehicle.

If the axial flux electrical machine is installed in a large watercraft, the available space for cooling the axial flux machine may be large. The cooling circuit may therefore include a large radiator or heat exchanger, and may provide heat energy to a circuit which provides heating for the passengers of the watercraft. Alternatively, if the cooling circuit is a closed loop, it may utilise the space for cooling by using a large radiator.

The liquid cooling arrangement may also be advantageous in the case of mechanically stacked axial flux electrical machines. Air cooling may not be sufficient for a plurality of axial flux electrical machines stacked together, and so for example, the liquid cooling arrangement of a first axial flux electrical machine in the stack may be connected to the liquid cooling arrangement of a second axial flux electrical machine in the stack, and so on. In an example, the outlet of the liquid cooling arrangement of the first axial flux electrical machine is connected to the inlet of the liquid cooling arrangement of the second axial flux electrical machine in the stack.

Liquid may then be passed through the cooling arrangement of both the first and second axial flux electrical machines. In an alternative example, a radiator or heat exchanger may be placed between the outlet of the cooling arrangement of the first axial flux electrical machine and the inlet of the second axial flux electrical machine in the stack. This may increase the cooling capacity.

In a further example, an axial flux electrical machine is mechanically affixed to a controller such that the controller and axial flux electrical machine form a single unit, and the cooling arrangement in the axial flux machine is configured to cool both the axial flux machine and the controller. In this example, a cooling plate may be provided between the axial flux electrical machine and the controller, the cooling plate being hollow and having an inlet and outlet for connection to a cooling circuit, or the like.

In a yet further example, an axial flux electrical machine is electrically attached, but not mechanically affixed to a controller. A further cooling channel may be provided in the controller, and the cooling circuit which cools the axial flux electrical machine may be extended in order to pass coolant through the cooling channel in the controller, thus also cooling the controller.

The following clauses define further preferred embodiments of the disclosure.
1. An outboard for use on a watercraft, the outboard comprising:
   a lower section for connection with a propeller;
   an upper section configured to mount an axial flux electrical machine; and
   a mid-section for housing a drive coupling extending between the axial flux electrical machine when housed in the upper section and the propeller when connected to the lower section.
2. The outboard according to clause 1, wherein the upper section comprises a stator housing for the axial flux electrical machine, the stator housing being integral to the upper section.
3. The outboard according to any preceding clause, further comprising a skeg coupled to the lower section, the skeg extending beneath the lower section of the outboard, wherein the skeg is made from a less durable material than the lower section.
4. The outboard according to any preceding clause, wherein the lower section, the mid-section and the upper section cooperate to define a cooling passage for cooling fluid to cool the axial flux electrical machine when housed in the upper section.
5. The outboard according to clause 4, wherein the cooling passage forms a closed loop within the outboard.
6. The outboard according to any of clauses 4 to 5, wherein the cooling passage leads through a heat exchanger.
7. The outboard according to clause 6, wherein the heat exchanger comprises a portion of the outboard which is configured to be submerged when in use.
8. The outboard according to one of clauses 4 to 7, wherein the cooling passage comprises a coolant pump housing portion for housing a coolant pump for pumping cooling fluid through the cooling passage.
9. The outboard according to any of clauses 4 to 8, wherein the upper section further comprises a controller housing for housing a controller for controlling the axial flux electrical machine when housed in the outboard, wherein the cooling passage is further configured such that cooling fluid flowing through the cooling passage cools the controller when housed within the outboard.
10. The outboard according to any preceding clause, the upper section further comprising one or more cover plates for covering one or more rotors of the axial flux electrical machine when housed within the upper section.
11. The outboard according to clause 2, wherein the stator housing is tubular and substantially cylindrical in shape, the inner surface of the stator housing comprising a plurality of recesses, each recess configured to receive an outer part of a conductive coil of the stator of the axial flux electrical machine.
12. The outboard according to clause 11, wherein the cross-section of each recess, perpendicular to the axis of rotation of the axial flux electrical machine, is elongate, the major dimension of each elongate recess extending substantially in the radial direction of the axial flux electrical machine.
13. The outboard according to clause 12, wherein each elongate recess has an aspect ratio of between about 5 and about 15.
14. The outboard according to any one of clauses 11-13, wherein the side walls of each recess are substantially parallel to the rotational axis of the axial flux electrical machine.
15. The outboard according to any of clauses 11 to 14, wherein the circumferential distance between adjacent recesses is between about 1 times and about 3 times the width of each recess.
16. The outboard according to any of clauses 11 to 15, further comprising an annular ring configured to form an annular channel adjacent the circumferential outer surface of said stator housing.
17. The outboard according to clauses 16, further comprising a spacer configured to divide said annular channel, the spacer extending from a first axial end of said stator housing to a second axial end of said stator housing.
18. The outboard according to clause 17, wherein said spacer mechanically couples said stator housing to said annular ring.
19. The outboard according to any of clauses 17 or 18, wherein said annular ring comprises a cooling fluid inlet disposed adjacent a first side of said spacer, and a cooling fluid outlet disposed adjacent a second side of said spacer, the inlet and the outlet being in fluid communication with the annular channel.
20. The outboard according to any of clauses 11 to 19, wherein said stator housing is formed by extrusion.
21. The outboard according to clause 20, wherein the plurality of recesses are formed from a first set of protrusions extending from the inner surface of the stator housing and a second set of protrusions extending from the inner surface of the stator housing, wherein the first set of protrusions are formed integrally with said stator housing, and the second set of protrusions are formed separately and positioned within said stator housing.
22. The outboard according to clause 21, wherein said second set of protrusions are mechanically attached to said stator housing.
23. The outboard according to clause 21 or 22, wherein said first set of protrusions are interlaced with said second set of protrusions.
24. The outboard according to clause 23, wherein said first set of protrusions are interlaced with said second set of protrusions such that each protrusion from the first set of protrusions is adjacent a protrusion from the second set of protrusions.
25. The outboard according to any of clauses 21 to 24, wherein each of the second set of protrusions comprise a key configured to engage with a corresponding slot formed in the inner surface of the extruded stator housing to mechanically attach each protrusion thereto.
26. The outboard according to any of clauses 21 to 24, wherein each of the second set of protrusions comprises a slot configured to engage with a corresponding key formed on the inner surface of the extruded stator housing to mechanically attach each protrusion thereto.
27. The outboard according to any of clauses 20 to 26, wherein the stator housing is extruded as a single part.
28. The outboard according to any of clauses 20 to 26, wherein the stator housing is formed of a plurality of circumferentially-interlocking extruded segments.
29. The outboard according to any of clauses 20 to 26, when dependent on any of claims 16 to 19, wherein said annular ring is formed by extrusion.
30. The outboard according to clause 29, when dependent on any of clauses 17 to 19, wherein said spacer is formed of a slot and key, the slot being formed on one of an inner surface of said annular ring and the outer surface of said stator housing, the key being formed on the other of the inner surface of said annular ring and the outer surface of said stator housing.
31. An outboard assembly comprising:
   an outboard according to any preceding clause;
   an axial flux electrical machine having a stator housed within the stator housing of the upper section;
   a propeller coupled to the lower section of the outboard; and
   a drive coupling extending between the axial flux electrical machine and the propeller.
32. The outboard assembly according to clause 31, wherein the propeller comprises a plurality of blades, each of the plurality of blades comprising a cutting portion on a leading edge for cutting fouling.
33. The outboard assembly according to any one of clauses 31 or 32, further comprising a controller housed within the upper section, wherein the controller is configured to control the axial flux electrical machine.
34. The outboard assembly according to any one of clauses 31 to 33, further comprising a coolant pump for pumping cooling fluid around an cooling loop of the outboard.
35. The outboard assembly according to clause 34, wherein the coolant pump is driven by the axial flux electrical machine.
36. The outboard assembly according to clause 34, wherein the coolant pump is driven by an electrical motor housed within the outboard.
37. A watercraft comprising the outboard assembly of any one of clauses 31 to 36.
38. A propeller for a watercraft, the propeller comprising a plurality of blades, wherein at least one of the plurality of blades comprises a cutting portion for cutting foulings.
39. The propeller according to clause 38, wherein the cutting portion is provided on a leading edge of the at least one blade.
40. The propeller according to any of clauses 38 or 39, wherein each of the plurality of blades comprise a cutting portion.
41. The propeller according to clause 40, wherein the cutting portion comprises a v-shaped blade portion situated a base of each of the plurality of blades such that adjacent blades are separated at their base.
42. The propeller according to any of clauses 38 to 41, wherein the cutting portion comprises a sharper edge than other edges of the blade.
43. The propeller according to any of clauses 38 or 42, wherein the cutting portion is made from a more durable material than other portions of the blade.
44. The propeller according to any of clauses 38 to 43, wherein the cutting portion is coated with a coating comprising at least one of polytetrafluoroethylene (PTFE), chromium nitride (CrN), boron carbide (B4C), molybdenum disulphide (MoS2), titanium nitride (TiN), titanium carbo-nitride (TiCN), aluminium-titanium nitride (AlTiN), or diamond-like carbon (DLC).

Described above are a number of embodiments with various optional features. It should be appreciated that, with the exception of any mutually exclusive features, any combination of one or more of the optional features are possible.

1. An outboard for a watercraft, the outboard having a body comprising:
a motor housing portion for housing an axial flux electrical machine and a controller; and
a closed cooling loop, for cooling fluid, configured to cool the axial flux electrical machine and the controller when housed in the motor housing portion, wherein the cooling loop is configured such that a portion thereof is submerged in water when the outboard is in use.

2. The outboard according to claim 1, wherein at least a portion of the cooling loop is situated adjacent an outer surface of the outboard, said outer surface being submerged in water when the outboard is in use.

3. The outboard according to claim 1, wherein the cooling loop extends through a mid-section of the outboard, the cooling loop in the mid-section having a cool side and a hot side, wherein the hot side is situated adjacent to a front surface of the mid-section when the outboard is in use.

4. The outboard according to claim 3, wherein the cooling loop is configured such that when the controller and axial flux electrical machine are housed within the motor housing portion the cool side of the cooling loop is configured to cool the controller before cooling the axial flux electrical machine.

5. The outboard according to claim 1, wherein the cooling loop comprises a heat exchanger.

6. The outboard according to claim 5, wherein the heat exchanger is provided in a portion of the outboard body which is configured to be submerged in water when the outboard is in use.

7. The outboard according to claim 5, wherein the heat exchanger is positioned adjacent to a front surface of the body of the outboard when in use.

8. The outboard according to claim 5, wherein the heat exchanger comprises a larger effective cross-sectional area than the cooling loop portions which put the motor housing portion in fluid communication with the heat exchanger.

9-10. (canceled)

11. The outboard according to claim 1, further comprising a transmission housing, wherein the cooling loop at least partially surrounds the transmission housing.

12. The outboard according to claim 1, wherein the cooling loop comprises a coolant pump configured to pump cooling fluid around the cooling loop.

13. The outboard according to claim 10, wherein the coolant pump is configured to be driven by an axial flux electrical machine housed within the motor housing portion.

14. The outboard according to claim 1, wherein the cooling loop further comprises an expansion vessel for controlling coolant pressure and/or coolant fill-level.

15. (canceled)

16. The outboard according to claim 1, wherein the motor housing portion comprises a stator housing for receiving a stator of the axial flux electrical machine.

17-44. (canceled)

45. An outboard assembly comprising:
an outboard according to claim 1;
an axial flux electrical machine housed within the motor housing portion;
a propeller coupled to a lower section of the outboard; and
a drive coupling extending between the axial flux electrical machine and the propeller.

46. The outboard assembly according to claim 14, wherein the propeller comprises a plurality of blades, wherein at least one of the plurality of blades comprises a cutting portion for cutting fouling.

47. The outboard assembly according to claim 15, wherein each of the plurality of blades comprise a cutting portion.

48. The outboard assembly according to claim 15, wherein the cutting portion comprises a sharper edge than other edges of the at least one blade.

49. The outboard assembly according to claim 15, wherein the cutting portion is made from a more durable material than other portions of the blade.

50. (canceled)

51. The outboard according to claim 14, further comprising a skeg extending beneath the lower section of the outboard, wherein skeg is made from a less durable material than the lower section.

52-54. (canceled)

55. A watercraft comprising the outboard assembly of claim 1.
